(19) United States
(12) Patent Application Publication
(10) Pub. No.: US 2016/0291224 A1
(43) Pub. Date: Oct. 6, 2016

(54) COMPOSITE POLARIZING PLATE

(71) Applicant: DONGWOO FINE-CHEM CO., LTD., Jeollabuk-do (KR)

(72) Inventors: Hong Jun AHN, Seoul (KR); Yong Won SEO, Gyeonggi-do (KR)

(21) Appl. No.: 15/085,018

(22) Filed: Mar. 30, 2016

(30) Foreign Application Priority Data
Mar. 31, 2015 (KR) 10-2015-0045297

(51) Int. Cl. G02B 5/30

(52) U.S. Cl. CPC G02B 5/3016

(57) ABSTRACT

A composite polarizing plate includes a polarizing plate having a polarization coating layer formed on one surface thereof, a retardation coating layer, and a photo-curable adhesive layer installed between the polarizing plate and the retardation coating layer, such that a display device having a thinner thickness and lighter weight may be implemented, and cracks may be reduced due to excellent flexibility, thereby the composite polarizing plate may be applied to a flexible display device.

### CROSS-REFERENCE TO RELATED APPLICATION

This application claims priority to and the benefit of Korean Patent Application No. 10-2015-0045279, filed on Mar. 31, 2015, the disclosure of which is incorporated herein by reference in its entirety.

### BACKGROUND

1. Field of the Invention

The present invention relates to a composite polarizing plate, and more specifically, to a composite polarizing plate which may be applied to a flexible display device due to excellent flexibility.

2. Description of the Related Art

As parts of a device are decreased in size and reduced in weight with a rapidly developing semiconductor technique as the central figure, a demand for a display device with improved performance is growing explosively in recent years.

Electronic displays for visually transmitting information have appeared in various types of electronic displays according to the information trend. Recently, according to development of mobile communications, development of a portable display is strongly becoming a primary issue in the market.

Such a display device has changed in a sequence of a liquid crystal display (LCD), a plasma display panel (PDP), an organic electro luminescence display (OLED), or the like in accordance with needs of the market. In particular, the liquid crystal display (LCD) has a low consumed power compared to an existing cathode ray tube method, and can be manufactured in a small size, and a thin thickness and light weight, as well as has an advantage that it does not emit hazardous electromagnetic waves. Thereby, the LCD is in the spotlight as a next generation high-tech display, and is mounted and used in almost all of the information processing equipment that require such a display device at present.

Recently, studies into a flexible display which is more thin and lighter than a conventional panel by using a polymer film instead of a glass substrate and can be bent to some degrees are actively conducted.

Such a flexible display may be manufactured in a form of plastic film LCDs, organic ELs, wearable displays, electronic books, electronic paper, or the like, with very wide range of applications. Therefore, the flexible display may also be applied to a product such as a display for a mobile communication terminal, or a display for a portable information communication device, which requires a flexible or various shaped display having high resistance to external shock or vibration, in addition to being thin and light.

However, in a case of a flexible liquid crystal display, only the material of a currently used substrate is changed from the existing glass substrate to a polymer film, other peripheral parts such as a polarizing plate, backlight, etc., which are required to implement the display, still use the same material and driving method as those applied to the glass substrate.

For example, a conventional liquid crystal display includes a polarizing plate having a thickness of 200 to 400 μm, and a protective layer having a thickness of 25 to 100 μm used for protecting a polarizer, and which are a limitation of a decrease in thickness and size. Due to this disadvantage, there is a difficulty to apply the conventional liquid crystal display to a thin structure such as a card.

In order to solve such a problem, Korean Patent Laid-Open Publication No. 2008-0073252 discloses a technique relating to the flexible liquid crystal display to achieve a thin structure by omitting a protective film contacting a liquid crystal cell, which is a component of a polarizing plate adhered to the liquid crystal cell.

However, this technique also has a difficulty to apply to a thin type flexible display due to the thickness of a substrate for forming the touch sensing electrode thereon.

### SUMMARY

Accordingly, it is an object of the present invention to provide a composite polarizing plate having a reduced thickness with a light weight.

Another object of the present invention is to provide a composite polarizing plate with excellent flexibility and anti-cracking property to flexing fatigue.

The above object of the present invention will be achieved by the following characteristics:

(1) A composite polarizing plate, including: a polarizing plate having a polarization coating layer formed on one surface thereof; a retardation coating layer; and a photo-curable adhesive layer installed between the polarizing plate and the retardation coating layer.

(2) The composite polarizing plate according to the above (1), wherein the polarizing plate includes a base film and a polarization coating layer disposed on one surface of the base film.

(3) The composite polarizing plate according to the above (1), wherein the polarization coating layer is made of a composition for forming a polarization coating layer which includes a polymerizable liquid crystal compound, a dichroic dye, a leveling agent and a solvent, and the retardation coating layer is made of a composition for forming a retardation coating layer which includes a polymerizable liquid crystal compound, a leveling agent and a solvent.

(4) The composite polarizing plate according to the above (3), wherein the polymerizable liquid crystal compound is represented by Formula 1 below:

U¹-V¹-W¹-X¹-Y¹-X²-Y²-X³-W²-V²-U² [Formula 1]

(wherein X¹, X² and X³ are each substituted or non-substituted p-phenylene or cyclohexane-1,4-diyl group, provided that at least one among these is p-phenylene group;

Y¹ and Y² are each independently direct bond, —CH₂CH₂—, —CH₂O—, —COO—, —OCOO—, —N═N—, —CR^{a}═CR^{b}—, —C≡C— or CR^{a}═N—;

U¹ is a hydrogen atom or polymerizable group;

U² is a polymerizable group;

W¹ and W² are each independently direct bond, —O—, —S—, —COO— or OCOO-group; and

V¹ and V² are each independently substituted or non-substituted alkanediyl group having 1 to 20 carbon atoms).

(5) The composite polarizing plate according to the above (1), wherein the polarization coating layer has a thickness of 0.5 to 10 μm, and the retardation coating layer has a thickness of 0.5 to 10 μm.

(6) The composite polarizing plate according to the above (1), wherein the photo-curable adhesive layer has an elastic modulus of 10 MPa or more.

(7) The composite polarizing plate according to the above (1), wherein the photo-curable adhesive layer has a thickness of 0.5 to 10 μm.

(8) An image display device including: the composite polarizing plate according to any one of the above (1) to (7).

The composite polarizing plate of the present invention is provided with a polarization coating layer and a retardation coating layer, therefore, a display device having a thinner thickness and lighter weight may be implemented when the above polarizing plate is applied to an image display device.

The composite polarizing plate of the present invention may have excellent flexibility, thereby reducing cracks occurred when flexing is continuously applied. Therefore, the composite polarizing plate may be applied to a flexible display device.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an SEM photograph illustrating a composite polarizing plate of Example 1;

FIG. 2 is an SEM photograph illustrating a composite polarizing plate of Example 3;

FIG. 3 is an SEM photograph illustrating a composite polarizing plate of Example 4;

FIG. 4 is an SEM photograph illustrating a composite polarizing plate of Example 8;

FIG. 5 is an SEM photograph illustrating a composite polarizing plate of Comparative Example 1; and

FIG. 6 is an SEM photograph illustrating a composite polarizing plate of Comparative Example 2.

### DETAILED DESCRIPTION

The present invention discloses a composite polarizing plate, including: a polarizing plate having a polarization coating layer formed on one surface thereof; a retardation coating layer; and a photo-curable adhesive layer installed between the polarizing plate and the retardation coating layer, such that a display device having a thinner thickness and lighter weight may be implemented, and cracks may be reduced due to excellent flexibility, thereby the composite polarizing plate may be applied to a flexible display device.

Hereinafter, the present invention will be described in detail.

The composite polarizing plate of the present invention includes: a polarizing plate provided with a polarization coating layer on one surface thereof; a retardation coating layer; and a photo-curable adhesive layer installed between the polarizing plate and the retardation coating layer.

In the present disclosure, the composite polarizing plate means a laminate having a composite configuration of a polarizing plate and a retardation plate.

A typical polarizing plate includes a polyvinyl alcohol polarizer (a polarizing film) and protective films adhered to both surfaces of the polarizer using an adhesive.

However, the composite polarizing plate of the present invention includes a polarizing plate provided with the polarization coating layer on one surface thereof. Therefore, it is possible to implement a composite polarizing plate having a more reduced thickness to thus show excellent flexibility.

Further, if flexing fatigue is continuously applied thereto, an occurrence of cracks may be reduced. Accordingly, the composite polarizing plate may be applied to a flexible display device.

More particularly, the polarizing plate of the present invention includes a base film and the polarization coating layer disposed on one surface of the base film.

The base film may use a transparent film made of any material widely used in the related art without particular limitation thereof. For example, the base film may be made of any one selected from a group consisting of cellulose ester (ex: cellulose triacetate, cellulose propionate, cellulose butyrate, cellulose acetate propionate and nitrocellulose), polyimide, polycarbonate, polyester (ex: polyethylene terephthalate, polyethylene naphthalate, poly-1,4-cyclohexanedimethylterephthlate, polyethylene 1,2-diphenoxyethane-4,4′-dicarboxylate and polybutylene terephthalate, polystyrene (ex: syndiotactic polystyrene), polyolefin (ex: polypropylene, polyethylene and polymethylpentene), polysulfone, polyethersulfone, polyarylate, polyether-imide, polymethylmethacrylate, polyether ketone, polyvinylalcohol and polyvinyl chloride, which may be used alone or as a mixture thereof.

A thickness of the base film is not particularly limited but, for example, may be 10 to 100 μm. If the thickness of the base film is less than the above range, processing may not be easily executed. If the thickness thereof exceeds the above range, flexibility is reduced due to excessively large thickness, and cracks may occur due to repeated flexing fatigue, hence causing a difficulty in applying the base film to the flexible display device.

The polarization coating layer may be formed by coating the base film with a composition for forming a polarizing layer then aligning the film.

The base film may include an alignment film formed on a surface thereof on which the polarization coating layer is formed.

The alignment film may include an aligned polymer or a composition containing the aligned polymer.

The aligned polymer may include a polymer such as polyamide or gelatins having an amide bond in a molecule, polyimide having an imide bond in a molecule and polyamic acid which is a hydrolysate thereof, polyvinyl alcohol, alkyl-modified polyvinylalcohol, polyacrylamide, polyoxazole, polyethyleneimine, polystyrene, polyvinylpyrrolidone, polyacrylic acid, polyacrylic acid esters, or the like. Among them, polyvinyl alcohol may be used. These polymers may be used alone, in combination of two or more thereof, or as a copolymer of two or more thereof. These polymers may be easily obtained by polycondensation by dehydration or deamination, radical polymerization, chain polymerization such as anionic polymerization and cationic polymerization, coordination polymerization, ring-opening polymerization, or the like.

In this case, the aligned polymer may be dissolved in the solvent and applied. The solvent usable herein may be water; an alcohol solvent such as methanol, ethanol, ethylene glycol, isopropyl alcohol, propylene glycol, methylcellosolve, butylcellosolve, propyleneglycolmonomethylether, etc.; an ester solvent such as ethyl acetate, butyl acetate, ethyleneglycolmethylether acetate, γ-butyrolactone, propyleneglycolmethylether acetate, ethyl lactate, etc.; a ketone solvent such as acetone, methylethylketone, cyclopentanone, cyclohexanone, methylamylketone, methylisobutylketone, etc.; an aliphatic hydrocarbon solvent such as pentane, hexane, heptane, etc.; an aromatic hydrocarbon solvent such as toluene, xylene, etc.; a nitrile solvent such as acetonitrile, etc.; an ether solvent such as tetrahydrofuran, dimethoxyethane, etc.; and a chlorine-substituted hydrocarbon solvent such as chloroform, chlorobenzene, or the like. These organic solvents may be used alone or in combination of two or more thereof.

Further, commercially available alignment film materials may include Sunever (registered trademark, Nissan Chemical Industries Ltd.), Optomer (registered trademark, JSR corporation), or the like.

For example, the alignment film may be formed on the base film by applying a solution of the aligned polymer or the commercially available alignment film materials on the base film, and then performing annealing thereon. The alignment film prepared as described above may have a thickness of, for example, 10 to 10000 nm, and more particularly, 10 to 1000 nm.

With regard to the alignment film, in order to endow an alignment control force, rubbing or polar UV irradiation may be executed if necessary. Endowing the alignment control force may enable a polymerizable liquid crystal compound to be aligned in a desired direction, which will be described below.

The rubbing method of an alignment film may include contacting a rotational rubbing tool having a rubbing cloth wound thereon to the alignment film carried and delivered by a stage. When masking during the rubbing or polar UV irradiation process, the resulting polarizer may also include a plurality of regions (patterns) formed therein, which have delayed phase shafts in different directions from each other.

A composition for forming a polarization layer may include a polymerizable liquid crystal compound, a dichroic dye, a leveling agent and a solvent.

The polymerizable liquid crystal compound is a polymerizable liquid crystal compound which represents a smectic phase. This compound may be, a polymerizable liquid crystal compound representing a nematic phase between a smectic phase representing temperature and an isotropic phase representing temperature. When the polymerizable liquid crystal compound is any one of the foregoing compounds, it tends to easily obtain a horizontally aligned smectic phase.

The smectic phase may include smectic A phase, smectic B phase, smectic D phase, smectic E phase, smectic F phase, smectic G phase, smectic H phase, smectic I phase, smectic J phase, and smectic K phase. Among them, the smectic B phase, smectic F phase, and smectic I phase may be used, and, for example, the smectic B phase may be used.

The polymerizable liquid crystal compound may include a compound represented by Formula 1 below.

U¹-V¹-W¹-X¹-Y¹-X²-Y²-X³-W²-V²-U² [Formula 1]

(wherein X¹, X² and X³ are each substituted or non-substituted p-phenylene or cyclohexane-1,4-diyl group, provided that at least one among these is p-phenylene group;

Y¹ and Y² are each independently direct bond, —CH₂CH₂—, —CH₂O—, —COO—, —OCOO—, —N═N—, —CR^{a}═CR^{b}—, —C≡C— or CR^{a}═N—;

U¹ is a hydrogen atom or polymerizable group;

U² is a polymerizable group;

W¹ and W² are each independently direct bond, —O—, —S—, —COO— or OCOO-group; and

V¹ and V² are each independently substituted or non-substituted alkanediyl group having 1 to 20 carbon atoms).

The p-phenyl group may be substituted with: an alkyl group having 1 to 4 carbon atoms such as methyl, ethyl, or butyl group, etc.; or a cyano group and a halogeno group (halogen atom) such as fluoro (fluorine atom), or chloro (chlorine atom), bromo group (bromine atom), etc., however, is preferably not substituted.

The substituent, which may be included in the cyclohexane-1,4-diyl group, may be substituted with an alkyl group having 1 to 4 carbon atoms such as methyl, ethyl, or butyl group, etc.; a cyano group and a halogeno group (halogen atom) such as fluoro (fluorine atom), chloro (chlorine atom), or bromo group (bromine atom), etc.; —O—; —S—; NR—, or the like. R is an alkyl group having 1 to 6 carbon atoms or phenyl group. For example, a trans-cyclohexane-1,4-diyl group may be used and this is more preferable than a non-substituted group.

U¹ and U² may be polymerizable groups, preferably, photo-radical polymerizable groups or photo-cationic polymerizable groups, and more preferably, the same types of groups.

The polymerizable group may include vinyl, vinyloxy, 1-chlorovinyl, isoprophenyl, 4-vinylphenyl, acryloyloxy, methacryloyloxy, oxiranyl, oxetanyl groups, and the like. Among them, the acryloyloxy, methacryloyloxy, vinyloxy, oxiranyl, and oxetanyl groups are preferably used, and the acryloyloxy group is more preferably used.

The alkanediyl group having 1 to 20 carbon atoms may be substituted with a cyano group and a halogeno group such as fluoro (fluorine atom), chloro (chlorine atom), or bromo group (bromine atom), etc.; —O—; —S—; NH—, or the like.

Alkanediyl group having 1 to 20 carbon atoms may include, for example, methylene, ethylene, propane-1,3-diyl, butane-1,3-diyl, butane-1,4-diyl, pentane-1,5-diyl, hexane-1,6-diyl, heptane-1,7-diyl, octane-1,8-diyl, decane-1,10-diyl, tetradecane-1,14-diyl and icosane-1,20-diyl groups, preferably, alkanediyl group having 2 to 12 carbon atoms, and more preferably, alkanediyl group having 6 to 12 carbon atoms.

The compound represented by Formula 1 may include, for example, compounds represented by Formulae (1-1) to (1-21) below.

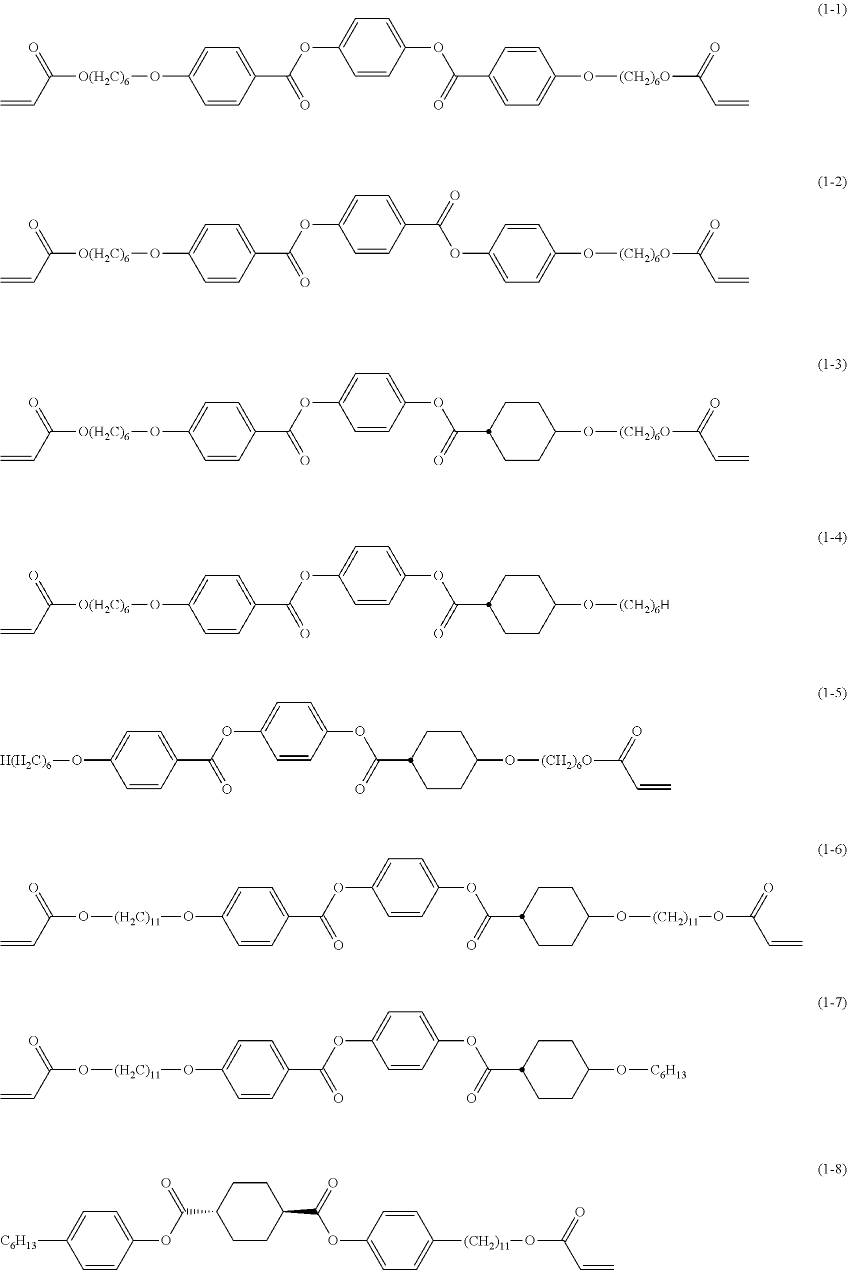

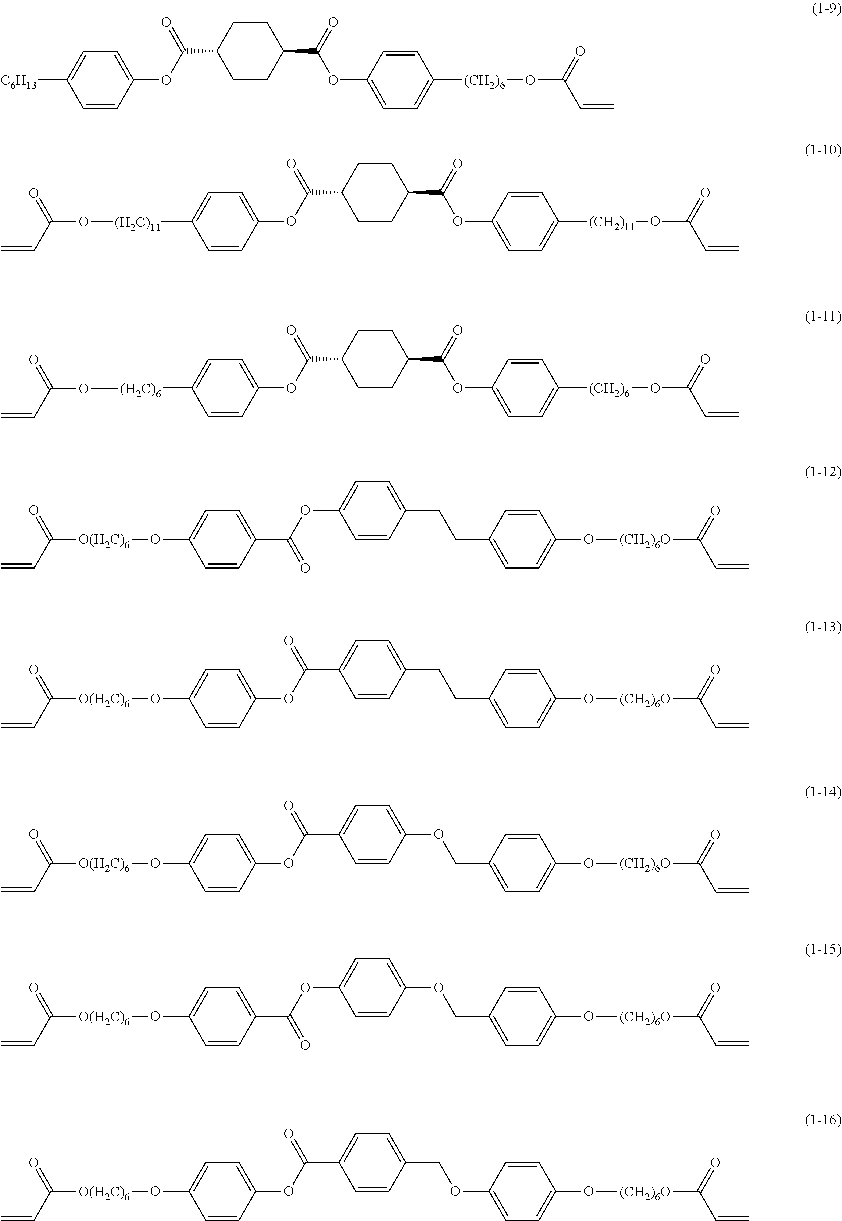

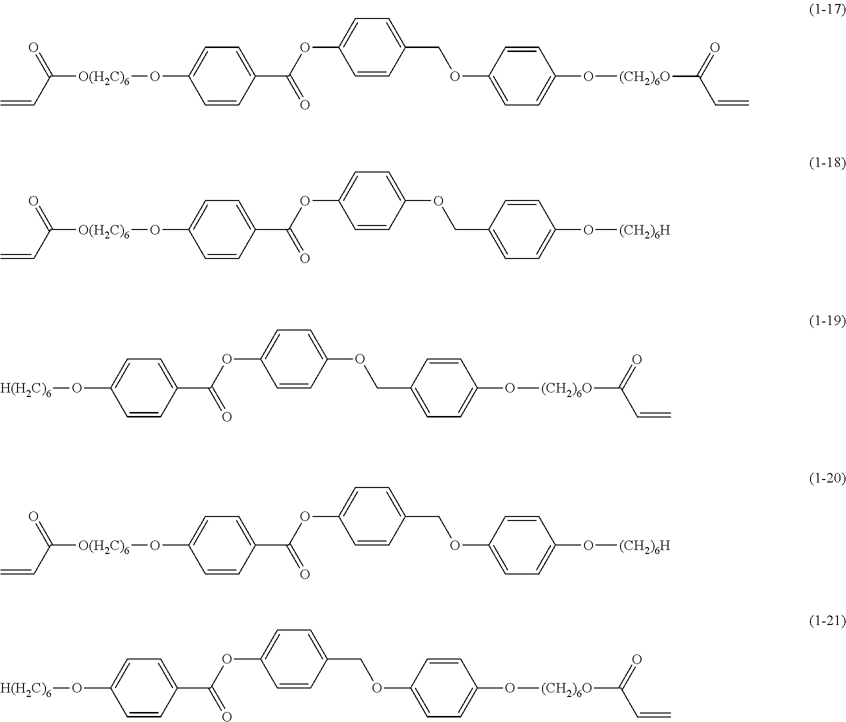

The polymerizable compound may be included in an amount of 70 to 99.9% by weight (‘wt. %’) to a total weight of solid content in the composition for forming a polarization coating layer. Within the above range, alignment property may be improved.

As the dichroic dye, both of dyes and pigments may be used. Preferably, the dichroic dye having a maximum absorption wavelength of 300 to 700 nm is preferably used. The dichroic dye may include, for example, acridine dyes, oxazine dyes, cyanine dyes, naphthalene dyes, azo dye and anthraquinone dyes. A combination of at least two types of dichroic dyes may also be used.

The dichroic dye is preferably azo dyes. Specifically, the azo dye may include monoazo dyes, bisazo dyes, trisazo dyes, tetrakis azo dyes, and stilbene azo dyes. More preferably, the bisazo dye and the trisazo dye are used.

The azo dye may include, for example, compounds represented by Formula 2 below.

Al(—N═N-A²)ₚ-N═N-A³ [Formula 2]

(wherein Al and A³ [symbol] are each independently substituted or non-substituted phenyl, naphthyl or mono-valent heterocyclic group;

A² is independently a substituted or non-substituted p-phenylene, naphthalene-1,4-diyl or di-valent heterocyclic group;

p is an integer of 1 to 4 and, when p is 2 or more, a plurality of A² may be the same or different from each other).

The mono-valent heterocyclic group may include, for example, a group remained by removing one hydrogen atom from a heterocyclic ring such as quinoline ring, thiazole ring, benzothiazole ring, thienothiazole ring, imidazole ring, benzothiazole ring, etc. Further, the di-valent hetercyclic group may include, for example, a group remained by removing two hydrogen atoms from the foregoing heterocyclic ring.

The phenyl, naphthyl and mono-valent heterocyclic group in A¹ and A³, and the p-phenylene, naphthalene-1,4-diyl and di-valent heterocyclic group in A² may include, for example: an alkyl group having 1 to 4 carbon atoms such as methyl, ethyl, or butyl group, etc.; an alkoxy group having 1 to 4 carbon atoms such as methoxy, ethoxy, or butoxy group, etc.; a fluoroalkyl group having 1 to 4 carbon atoms such as trifluoromethyl group; a cyano group; a nitro group; a halogeno group such as fluoro, chloro, or bromo group etc.; an amino group; an amino group substituted by alkyl group having 1 to 4 carbon atoms such as diethylamino, or pyrrolidine group, etc. (two alkyl groups substituted by amino groups may be combined to form an alkanediyl group having 2 to 8 carbon atoms).

The azo dye is preferably compounds represented by Formulae (2-1) to (2-6) below.

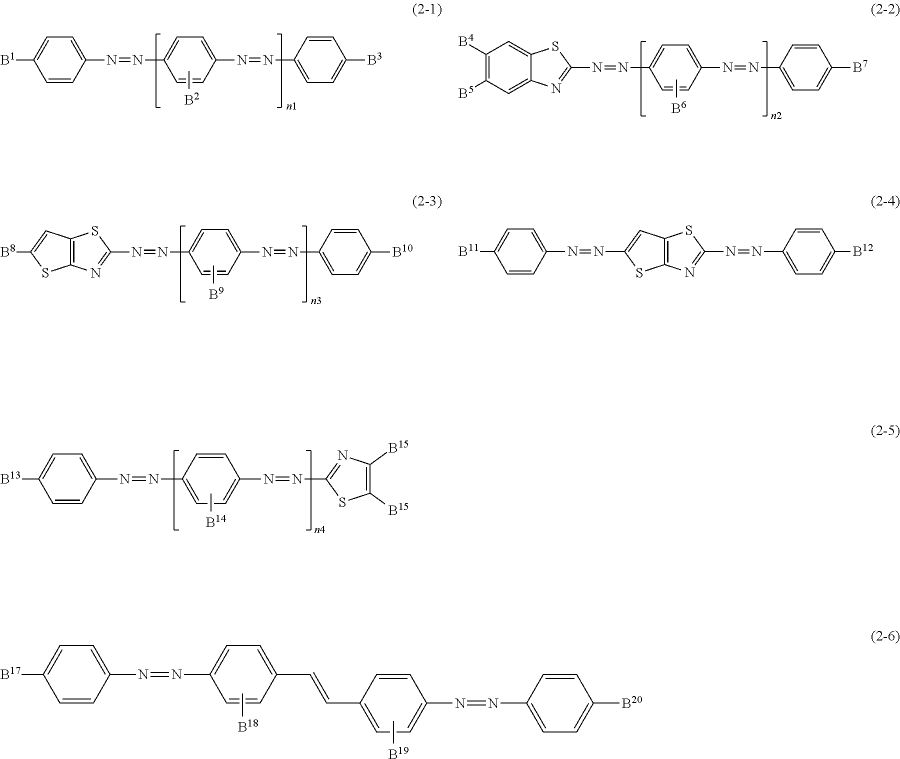

(wherein B¹ and B²⁰ are each independently hydrogen atom, an alkyl group having 1 to 4 carbon atoms, an alkoxy having 1 to 4 carbon atoms, a cyano, nitro, amino, or amino group substituted by alkyl group having 1 to 4 carbon atoms (two alkyl groups are combined to form an alkanediyl group having 2 to 8 carbon atoms), chloro (chlorine atom) or trifluoromethyl group; and

n1 and n4 are each independently integer of 0 to 3).

The anthraquinone dye may include, for example, a compound represented by Formula (2-7) below.

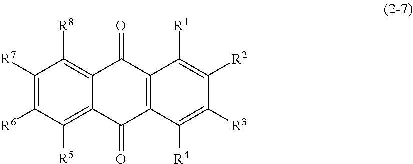

(wherein R¹ and R⁸ are each independently hydrogen atom, —R^{x}, an amino group, —NHR^{x}, —SR^{x} or halogen atom; and

R^{x} is an alkyl group having 1 to 4 carbon atoms or aryl group having 6 to 12 carbon atoms).

The acridine dye may include, for example, a compound represented by Formula (2-8) below.

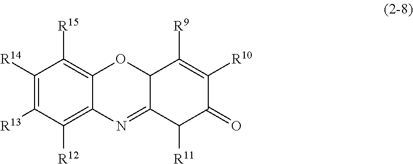

(wherein R⁹ to R¹⁵ are each independently hydrogen atom, —R^{x}, an amino group, —NHR^{x}, —SR^{x} or halogen atom; and

R^{x} is an alkyl group having 1 to 4 carbon atoms or aryl group having 6 to 12 carbon atoms).

The oxazone dye may include, for example, a compound represented by Formula (2-9) below.

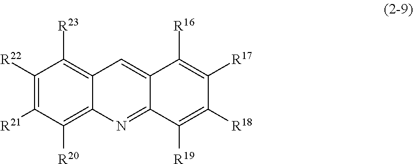

(wherein R¹⁶ to R²³ are each independently hydrogen atom, —R^{x}, an amino group, —NHR^{x}, —SR^{x} or halogen atom; and

R^{x} is an alkyl group having 1 to 4 carbon atoms or aryl group having 6 to 12 carbon atoms).

The alkyl group having 1 to 4 carbon atoms in R^{x} may include, for example, a methyl, ethyl, propyl, or butyl group, etc. The aryl group having 6 to 12 carbon atoms in R^{x} may include, for example, a phenyl, tolyl, xylyl, or naphthyl group, etc.

The cyanine dye may include, for example, compounds represented by Formulae (2-10) and (2-11) below.

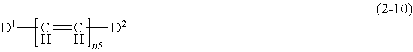

(wherein D¹ and D² are each independently groups represented by Formulae (2-10a) to (2-10d) below; and

n5 is an integer of 1 to 3)

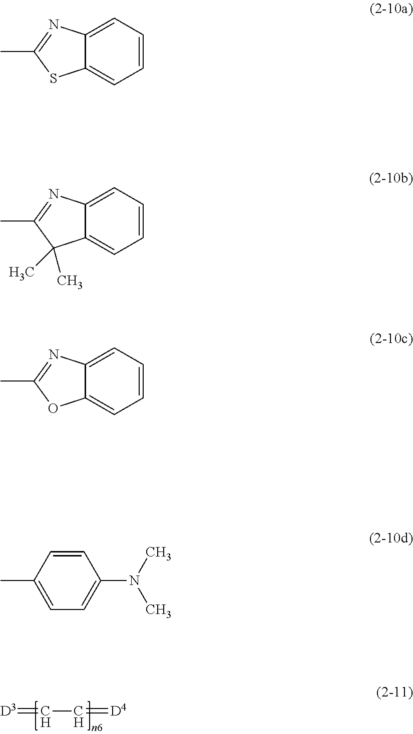

(wherein D³ and D⁴ are each independently groups represented by Formulae (2-11a) to (2-11h) below; and

n6 is an integer of 1 to 3)

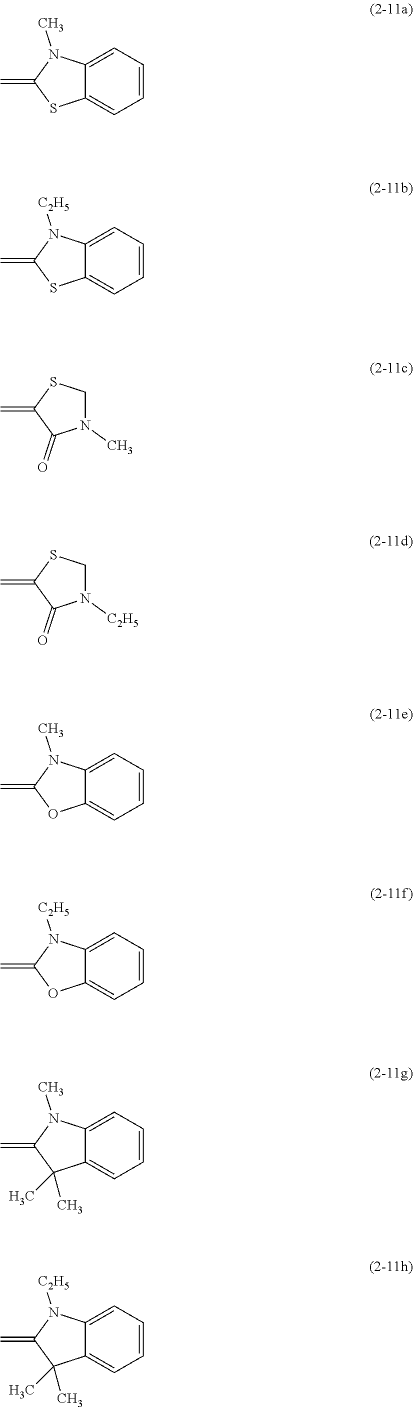

The dichroic dye may be included in an amount of 50 parts by weight (‘wt. parts’) or less, preferably, 0.1 to 20 wt. part, and more preferably, 0.1 to 10 wt. parts to 100 wt. parts of the polymerizable liquid crystal compound. If a content of the dichroic dye exceeds 50 wt. parts, alignment property of the polymerizable liquid crystal compound may be deteriorated.

The leveling agent may use anyone selected from a group consisting of a leveling agent having a polyacrylate compound as a major component, a leveling agent having a fluorine atom as a major component, and a combination thereof.

Specifically, the leveling agent having a polyacrylate compound as a major component may include BYK-350, BYK-352, BYK-353, BYK-354, BYK-355, BYK-358N, BYK-361N, BYK-380, BYK-381, and BYK-392 (which are manufactured by BYK Chemie Co.).

The leveling agent having a fluorine atom as a major component may include Megaface (trade name) R-08, Megaface R-30, Megaface R-90, Megaface F-410, Megaface F-411, Megaface F-443, Megaface F-445, Megaface F-470, Megaface F-471, Megaface F-477, Megaface F-479, Megaface F-482, Megaface F-483 (which are manufactured by DIC Co., Ltd.), Saffron (trade name) S-381, Saffron S-382, Saffron S-383, Saffron S-393, Saffron SC-101, Saffron SC-105, KH-40, SA-100 (which are manufactured by AGC Seimi Chemical Co., Ltd.), E1830 (trade name), E5844 (which are manufactured by Daikin industries, Ltd., fine chemical), FTOP (trade name) EF301, FTOP EF303, FTOP EF351, FTOP, and EF352 (which are manufactured by Mitsubishi Materials Electronic Chemicals Co., Ltd.).

A content of the leveling agent may be included in an amount of 0.3 to 5 wt. parts, and preferably, 0.5 to 3 wt. parts to 100 wt. parts of the polymerizable liquid crystal compound. When the content of the leveling agent is within the above range, components contained in a polymerizable liquid crystal composition may be easily horizontally aligned, and the flattened coating layer may be obtained. If the content of the leveling agent exceeds 5 wt. parts, smearing may easily occur therein.

The leveling agent may be at least one selected from a group consisting of a leveling agent including a polyacrylate compound as a major component and a leveling agent including a fluorine atom-containing compound, or a combination of two or more thereof.

The leveling agent is preferably a polyacrylate compound, a fluorine atom-containing compound or both of these compounds.

The solvent may be a solvent capable of dissolving individual components contained in the polymerizable liquid crystal composition. Further, the solvent may be a solvent not active to polymerization of the polymerizable liquid crystal composition.

The solvent may include, for example, alcohol solvents; ester solvents; ketone solvents; aliphatic hydrocarbon solvents; aromatic hydrocarbon solvents; nitrile solvents; ether solvents; chlorine-containing solvents, etc. These may be used alone or in combination of two or more thereof.

The solvent may be included in an amount of 50 to 98 wt. % to a total weight of the composition for forming a polarization coating layer. If a content of the solvent is less than 50 wt. %, a thickness of the formed coating layer is small and may cause a difficulty in achieving desired performance of a polarizer. If the content exceeds 98 wt. %, a viscosity of the composition is decreased to hence cause a difficulty in forming the coating layer, and stains may occur.

The composition for forming a polarization coating layer may further include a polymerization initiator.

The polymerization initiator is a compound to initiate polymerization of the polymerizable liquid crystal compound, and may generate active radicals or acid by reaction of light and/or heat. Among them, the polymerization initiator generating active radicals or acid through light, that is, a photo-polymerization initiator is preferably used. More preferably, a photo-polymerization initiator generating active radicals through light irradiation is used.

The photo-polymerization initiator may include, for example, benzoin compounds, benzophenone compounds, alkylphenone compounds, acylphosphin oxide compounds, triazine compounds, iodonium salts, sulfonium salts, or the like.

The photo-polymerization initiator may include conventional photo-polymerization initiators commercially available in the art, for example, Irgacure 907, Irgacure 184, Irgacure 651, Irgacure 819, Irgacure 250, Irgacure 369 (all of which are manufactured by Chiba-Geigy Japan Co. Ltd.), SEIKUOL BZ, SEIKUOL Z, SEIKUOL BEE (all of which are manufactured by Seko Kagaku Co. Ltd.), Kayacure BP100 (manufactured by Nihon Kayaku Co. Ltd.), Kayacure UVI-6992 (manufactured by Dow Co.), Adekaoptomer SP-152 or Adekaoptomer SP-170 (all of which are manufactured by Adeka Co. Ltd.), TAZ-A, TAZ-PP (all of which are manufactured by Nihon Siibel Haigner Co. Ltd.), TAZ-104 (Sanwa Chemical Co.), or the like.

The thermal-polymerization initiator may include, for example, azo compounds such as azobisisobutyronitrile; peroxides such as hydrogen peroxide, persulfates, benzoyl peroxide, or the like.

The polymerization initiator may be included in an amount of 0.1 to 30 wt. parts, preferably, 0.5 to 10 wt. parts, and more preferably, 0.5 to 8 wt. parts to 100 wt. parts of the polymerizable liquid crystal compound. When the content is within the above range, polymerization may possibly proceed while not inhibiting alignment of the polymerizable liquid crystal compound.

When using the photo-polymerization initiator as the polymerization initiator, a photo-sensitizer may be used together with the same. The photo-sensitizer may include, for example: xanthone compounds such as xanthone, thioxanthone (i.e., 2,4-diethyl thioxanthone, 2-isopropyl thioxanthone), etc.; anthracene compounds such as anthracene, alkoxy group-containing anthracene (i.e, dibutoxy anthracene), etc.; phenothiazine; rubrene, or the like.

Using the photo-sensitizer may enable polymerization of the polymerizable liquid crystal compound to become highly sensitive. The photo-sensitizer may be included in an amount of 0.1 to 30 wt. parts, preferably, 0.5 to 10 wt. parts, and more preferably, 0.5 to 8 wt. parts to 100 wt. parts of the polymerizable liquid crystal compound.

The composition for forming a polarization coating layer may further include a polymerization inhibitor. Polymerization of a polymerizable liquid crystal compound may be easily controlled by adding the polymerization inhibitor to thus improve stability of the composition.

The polymerization inhibitor may include, for example: a radical support such as hydroquinone, alkoxy group-containing hydroquinone, alkoxy group-containing catechol (ex., butyl catechol, etc.), pyrogallol, 2,2,6,6-tetramethyl-1-piperidinyloxy radical, etc.; thiophenols; β-naphthylamines; β-naphthols, or the like.

The polymerization inhibitor may be included in an amount of 0.1 to 30 wt. parts, preferably, 0.5 to 10 wt. parts, and more preferably, 0.5 to 8 wt. parts to 100 wt. parts of the polymerizable liquid crystal compound. When a content of the inhibitor is within the above range, polymerization can proceed while not inhibiting alignment of the polymerizable liquid crystal compound.

The composition for forming a polarization coating layer may be dried after applying the same.

The drying method may include, for example, natural drying, air drying, vacuum drying, etc. A drying temperature may be 0° C. to 250° C., and preferably, 50° C. to 220° C. A drying time may be 10 seconds to 60 minutes, and preferably, 30 seconds to 30 minutes. The polymerizable liquid crystal compound included in the composition may be heated to a temperature at which a liquid crystal phase appears. The liquid crystal phase is preferably a smectic phase. In addition, by heating the polymerizable liquid crystal compound to at least a temperature at which the compound is transited into a nematic phase, then, cooling the compound up to a temperature at which the compound exhibits the smectic phase, a film having the smectic phase formed therein is preferably obtained.

Through the nematic phase, the leveling agent included in the composition for forming a polarization coating layer can flow well to thus easily provide a horizontally aligned film.

A heating temperature may be of a nematic phase transition point to a temperature 100° C. higher than the nematic phase transition point, and preferably, the nematic phase transition point to a temperature 50° C. higher than the nematic phase transition point. The above drying as well as the heating for alignment into a liquid crystal phase may also be executed simultaneously.

Next, by polymerizing the polymerizable liquid crystal compound included in the film having a liquid crystal phase formed thereon, a polarizing plate may be obtained. The polymerization method may be a thermal polymerization or photo-polymerization method according to the polymerizable group included in the polymerizable liquid crystal compound. For the photo-polymerization, a low heat resistant base film may be used, thus being preferable.

A thickness of the polarization coating layer is not particularly limited but, for example, may be 0.5 to 10 μm. If the thickness is less than 0.5 μm, it may be difficult to attain sufficient polarizing performance. If the thickness thereof exceeds 10 μm, flexibility is reduced to cause an occurrence of cracks in the composite polarizing plate due to flexing fatigue. In an aspect of simultaneously expressing excellent polarizing performance and flexibility, the polarization coating layer preferably has a thickness of 0.5 to 5 μm.

The retardation coating layer is a coating layer implementing excellent contrast and may be made of a composition for forming a retardation coating layer.

In general, the retardation film includes a base film and a liquid crystal layer. However, the composite polarizing plate of the present invention has only a retardation coating layer instead of the retardation film, thus reducing a thickness and weight thereof. As a result, flexibility may also be improved to exhibit excellent anti-cracking property to flexion.

The composition for forming a retardation coating layer may have the same constitutional composition as that of the foregoing composition for forming a polarization coating layer, except for excluding the dichroic dye.

The retardation coating layer may be formed by applying the composition for forming a retardation coating layer to a transcript film, aligning the same, attaching the prepared layer to an adhesive layer and removing the transcript film, but it is not particularly limited thereto.

The transcript film may include the polymer film exemplified as the base film described above.

A thickness of the retardation coating layer is not particularly limited but, for example, may be 0.5 to 10 μm. If the thickness is less than 0.5 μm, it may be difficult to attain sufficient retardation performance. If the thickness thereof exceeds 10 μm, flexibility is reduced to cause an occurrence of cracks in the composite polarizing plate due to flexing fatigue.

In an aspect of simultaneously expressing excellent retardation performance and flexibility, the retardation coating layer preferably has a thickness of 0.5 to 5 μm.

The adhesive layer may be installed between the polarizing plate and the retardation coating layer and serve to combine both of them.

Conventionally, a PSA (pressure sensitive adhesive) is used to combine the polarizing plate and the retardation plate and, in a case of such a composite polarizing plate formed using the PSA, flexibility is low and a problem of occurring cracks is caused when flexing fatigue is repeatedly applied.

However, unlike this, the present invention may solve the above problem using an adhesive.

More particularly, the composite polarizing plate of the present invention includes the polarization coating layer and the retardation coating layer, therefore, may implement more reduction in thickness and weight than the conventional polarizing plate and the retardation film, and may exhibit excellent flexibility. Further, the flexibility may be further improved by attaching the foregoing coating layers through a high elasticity adhesive instead of the PSA.

As such, the composite polarizing plate of the present invention exhibits noticeably improved flexibility and has excellent anti-cracking property to flexing fatigue, thereby being preferably applied to the flexible display device. The photo-curable adhesive layer is disposed on one surface of the polarizing plate, in particular, may be positioned on the polarization coating layer side of the polarizing plate or on the base film side.

The photo-curable adhesive layer according to the present invention may have an elastic modulus of 10 MPa or more. When the elastic modulus is less than 10 MPa, effects of improving flexing cracks are reduced to cause an occurrence of cracks in the composite polarizing plate due to flexing fatigue. In an aspect of simultaneously expressing excellent adhesion and flexible property, the elastic modulus preferably ranges from 10 to 10⁴ MPa.

The photo-curable adhesive layer may be formed using a photo-curable adhesive composition including the photo-curable compound and the photo-polymerization initiator.

The photo-polymerizable compound is not particularly limited so far as the adhesive layer serves to achieve the above range of elastic modulus. For example, an acryl monomer, epoxy monomer, vinylether monomer, oxetane monomer, etc. may be used. In an aspect of attaining excellent elastic modulus, the epoxy monomer, vinylether monomer and oxetane monomer are preferably used. These compounds may be used alone or in combination of two or more thereof.

The acryl monomer may include, for example: such as methyl(meth)acrylate, ethyl(meth)acrylate, n-propyl(meth)acrylate, n-butyl(meth)acrylate, isobutyl(meth)acrylate, tert-butyl(meth)acrylate, (meth)acrylate, cyclohexyl(meth)acrylate, 2-ethylhexyl(meth)acrylate, lauryl(meth)acrylate, (meth)acrylate, 2-methoxyethyl(meth)acrylate, (meth)acrylate, 2-hydroxyethyl(meth)acrylate, 2-hydroxypropyl(meth)acrylate, 2-hydroxybutyl(meth)acrylate, 4-hydroxybutyl(meth)acrylate, glycerol mono(meth)acrylate, 3-chloro-2-hydroxypropyl(meth)acrylate, 2-hydroxy-3-phenoxypropyl(meth)acrylate, ethyleneglycol di(meth)acrylate, diethyleneglycol di(meth)acrylate, triethyleneglycol di(meth)acrylate, butyleneglycol di(meth)acrylate, nonaethyleneglycol di(meth)acrylate, polypropyleneglycol di(meth)acrylate, dipropyleneglycol di(meth)acrylate, neopentylglycol di(meth)acrylate, 1,3-butanediol di(meth)acrylate, 1,4-butanediol di(meth)acrylate, 1.6-hexanediol di(meth)acrylate, trimethylolpropane tri(meth)acrylate, neopentylglycol di(meth)acrylate, pentaerythritol tri(meth)acrylate, trimethylolmethane tri(meth)acrylate, isobornyl(meth)acrylate, N-vinyl pyrrolidone, acryloyl morphorine, urethane (meth)acrylate, tetrahydrofurfuryl(meth)acrylate, (meth)acrylate of mono-ε-caprolactone adduct of tetrahydrofurfuryl alcohol, (meth)acrylate of di-ε-caprolactone adduct of tetrahydrofurfuryl alcohol, (meth)acrylate of mono-β-methyl-δ-balerolactone adduct of tetrahydrofurfuryl alcohol, (meth)acrylate of di-β-methyl-δ-balerolactone adduct of tetrahydrofurfuryl alcohol, ω-carboxy-polycaprolactone monoacrylate, dimethylaminoethyl acrylate, or the like. These compounds may be used alone or in combination of two or more thereof.

The epoxy monomer may include, for example, aromatic epoxy compounds, alicyclic epoxy compounds, aliphatic epoxy compounds, or the like.

The aromatic epoxy compounds may include, for example, diglycidylether of bisphenol A, diglycidylether of bisphenol F, phenoxyglycidylether, or the like.

The alicyclic epoxy compounds may include, for example, dicyclopentadiene oxide, limonene dioxide, 4-vinylcyclohexene dioxide, 3,4-epoxycyclohexylmethyl-3,4-epoxycyclohexane carboxylate, bis(3,4-epoxycyclohexylmethyl)adipate, or the like.

The aliphatic epoxy compounds may include, for example, 1,6-hexanediol diglycidylether, 1,4-butanediol diglycidylether, trimethylolpropane triglycidylether, pentaerythritol tetraglycidylether, polytetramethyleneglycol diglycidylether, or the like.

The vinylether monomer may include, for example, diethyleneglycol divinylether, triethyleneglyocol divinylether, cyclohexylvinylether, polyethyleneglycol divinylether, 1,4-cyclohexanedimethylol divinylether, or the like. These compounds may be used alone or in combination of two or more thereof.

The octetane monomer may include, for example, 2-ethylhexyloxetane, xylidene bisoxetane, 3-ethyl-3-hydroxymethyloxetane, 1,4-bis[(3-ethyloxetan-3-yl)methoxymethyl]benzene, 3-ethyl-3-(2-ethylhexyloxymethyl)oxetane, bis(3-ethyl-3-oxetanylmethyl)ether, 3-ethyl-3-(phenoxymethyl)oxetane, 3-ethyl-3-(cyclohexyloxymethyl)oxetane, phenol novolac oxetane, 1,3-bis[(3-ethyloxetan-3-yl)methoxy]benzene, or the like. These compounds may be used alone or in combination of two or more thereof.

The photo-polymerization initiator may be any conventional cationic initiator or radical initiator.

The cationic initiator may include, for example, onium salt compounds, iron-arene composite, or the like.

The onium salt compound may include, for example: aromatic diazonium salts such as benzene diazonium hexafluoroantimonate, benzenediazonium hexafluorophosphate, benzenediazonium hexafluoroborate, etc.; aromatic iodonium salts such as diphenyliodonium tetrakis(pentafluorophenyl)borate, diphenyliodonium hexafluorophosphate, diphenyliodonium hexafluoroantimonate, di(4-nonylphenyl)iodonium hexafluorophosphate, etc.; aromatic sulfonium salts such as triphenylsulfonium hexafluorophosphate, triphenylsulfonium hexafluoroantimonate, triphenylsulfonium tetrakis(pentafluorophenyl)borate, diphenyl[4-(phenylthio)phenyl]sulfonium hexafluoroantimonate, 4,4′-bis[diphenylsulfonio]diphenylsulfide bishexafluorophosphate, 4,4′-bis[di(p-hydroxyethoxy)phenylsulfonio]diphenylsulfide bishexafluoroantimonate, 4,4′-bis[di(P-hydroxyethoxy)phenylsulfonio]diphenylsulfide bishexafluorophosphate, 7-[di(p-toluyl)sulfonio]-2-isopropylthioxanthone hexafluoroantimonate, 7-[di(p-toluyl)sulfonio]-2-isopropylthioxanthone tetrakis(pentafluorophenyl)borate, 4-phenylcarbonyl-4′-diphenylsulfonio-diphenylsulfide hexafluorophosphate, 4-(p-tert-butylphenylcarbonyl)-4′diphenylsulfonio-diphenylsulfide hexafluoroantimonate, 4-(p-tert-butylphenylcarbonyl)-4′di(p-toluyl)sulfonio-diphenylsulfide tetrakis(pentafluorophenyl)borate, diphenyl[4-(phenylthio)phenyl]sulfonium phosphate, etc.

The iron-arene composite may include, for example, xylene-cyclopentadienyl iron(II) hexafluoroantimonate, cumene-cyclopentadienyl iron(II) hexafluorophosphate, xylene-cyclopentadienyl iron(II)-tris(trifluoromethylsulfonyl)metanide, or the like.

The radical initiator may include, for example, acetophenone-, benzoin-, benzophenone-, thioxanthone-, triazine-based compounds, or the like. These compounds may be used alone or in combination of two or more thereof.

The acetophenone compound may include, for example, diethoxyacetophenone, 2-hydroxy-2-methyl-1-phenylpropan-1-one, benzyldimethylketal, 2-hydroxy-2-methyl-1-[2-(2-hydroxyethoxy)phenyl]propan-1-one, 1-hydroxycyclohexylphenylketone, 2-methyl-2-morpholino-1-(4-methylthiophenyl)propan-1-one, 2-benzyl-2-dimethylamino-1-(4-morpholinophenyl)butan-1-one and oligomer of 2-hydroxy-2-methyl-1-[4-(1-methylvinyl)phenyl]propan-1-one, or the like.

The benzoin compound may include, for example, benzoin, benzoin methylether, benzoin ethylether, benzoin isopropylether, benzoin isobutylether, or the like.

The benzophenone compound may include, for example, benzophenone, methyl o-benzoyl benzoate, 4-phenyl benzophenone, 4-benzoyl-4′-methyldiphenylsulfide, 3,3′,4,4′-tetra(t-butylperoxycarbonyl)benzophenone, 2,4,6-trimethylbenzophenone, or the like.

The thioxanthone compound may include, for example, 2-isopropylthioxanthone, 4-isopropylthioxanthone, 2,4-diethylthioxanthone, 2,4-dichlorothioxanthone, 1-chloro-4-propoxythioxanthone, or the like.

The triazine compound may include, for example: 2,4-bis(trichloromethyl)-6-(4-methoxyphenyl)-1,3,5-triazine; 2,4-bis(trichloromethyl)-6-(4-methoxynaphthyl)-1,3,5-triazine; 2,4-bis(trichloromethyl)-6-piperonyl-1,3,5-triazine; 2,4-bis(trichloromethyl)-6-(4-methoxystyryle)-1,3,5-triazine; 2,4-bis(trichloromethyl)-6-[2-(5-methylfuran-2-yl)ethenyl]-1,3,5-triazine; 2,4-bis(trichloromethyl)-6-[2-(furan-2-yl)ethenyl]-1,3,5-triazine; 2,4-bis(trichloromethyl)-6-[2-(4-diethylamino-2-methylphenyl)ethenyl]-1,3,5-triazine; 2,4-bis(trichloromethyl)-6-[2-(3,4-dimethoxyphenyl)ethenyl]-1,3,5-triazine, and the like.

A content of the photo-polymerization initiator is not particularly limited but, for example, may be included in an amount of 0.1 to 10 wt. parts to 100 wt. parts of the photo-polymerizable compound. When the content is within the above range, curing may proceed to a desirable level to thus form an adhesive layer with the above range of elastic modulus.

The adhesive layer may be formed by applying a photo-curable adhesive composition to the polarization coating layer or retardation coating layer and curing the same.

A thickness of the adhesive layer is not particularly limited but, for example, may be 0.5 to 10 μm. If the thickness is less than 0.5 μm, cohesive force and elastic modulus are reduced. If the thickness thereof exceeds 10 μm, flexibility is reduced to cause an occurrence of cracks in the composite polarizing plate due to flexing fatigue. In an aspect of simultaneously expressing excellent cohesive force and flexibility, the adhesive layer preferably has a thickness of 0.5 to 5 μm.

Further, the present invention provides an image display device including the above-described composite polarizing plate.

The composite polarizing plate of the present invention may be applicable to typical liquid crystal display devices, in addition, other different image display devices such as electro-luminescent display device, plasma display device, electro-luminescent emission display device, or the like.

The composite polarizing plate of the present invention may have excellent flexibility to thus reduce cracks occurring when flexing fatigue is repeatedly applied, thereby being preferably applied to, in particular, a flexible image display device.

While preferred embodiments have been described to more concretely understand the present, however, it will be apparent to those skilled in the related art that such embodiments are provided for illustrative purposes without limitation of appended claims, various modifications and alterations may be possible without departing from the scope and spirit of the present invention, and such modifications and alterations are duly included in the present invention as defined by the appended claims.

### Preparative Example 1

### Preparation of Composition for Forming Polarization Coating Layer

Compound (1-6) was synthesized by the method described in Lub et al., Recl. Tray. Chim. Pays-Bas, 115, 321-328(1996).

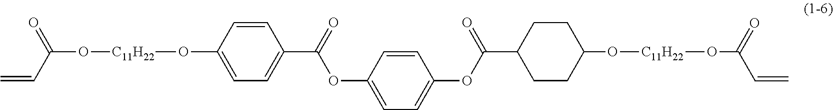

Then, 100 wt. parts of the compound (1-6), 2 wt. parts of an azo dye (NKX2029; manufactured by Hayashibara Seibutz Gagaku Genkyuzyo Co.), 6 wt. parts of 2-dimethylamino-2-benzyl-1-(4-morpholinophenyl)butan-1-one (Irgacure 369; manufactured by BASF Japan Co.) as a polymerization initiator, 2 wt. parts of isopropyl thioxanthone (manufactured by Nihon Siibel Haigner Co.) as a photo-sensitizer, 1.2 wt. parts of polyacrylate compound (BYK-361N; manufactured by BYK-Chemie Co.) as a leveling agent and 250 wt. parts of cyclopentanone as a solvent were admixed to prepare a mixture, followed by agitating the mixture at 80° C. for 1 hour to prepare a composition for forming a polarization coating layer.

### Preparative Example 2

### Preparation of Composition for Forming Retardation Coating Layer

A composition for forming a retardation coating layer was prepared by the same procedures as described in Preparative Example 1 except that the azo dye was not included.

### Preparative Example 3

### Preparation of Adhesive Composition

45 wt. parts of phenoxyglycidylether, 55 wt. parts of 3,4-epoxycyclohexymethyl 3,4-epoxycyclohexane carboxylate and 2 wt. parts of CPI-110A (Sanepro Co.) were admixed to prepare an adhesive composition.

### Preparative Example 4

### Preparation of Adhesive Composition

25 wt. parts of 3,4-epoxycyclohexylmethyl-3,4′-epoxycyclohexane carboxylate (Celloxide 2021P, Dicel Co.), 25 wt. parts of 1,4-cyclohexane dimethyloldiglycidylether, 35 wt. parts of 3-ethyl-3-[(3-ethyloxetan-3-yl)methoxymethyl]oxetane (Doa Goshei Aron Oxetane DOX221), 15 wt. parts of 3-ethyl-3-hydroxymethyloxetane (Doa Goshei Aron Oxetane OXA) and 5 wt. parts of CPI-100P (Sanepro Co.) were admixed to prepare an adhesive composition.

### Preparative Example 5

### Preparation of Adhesive Composition

47 wt. parts of 4-hydroxybutyl acrylate, 50 wt. parts of dimethylaminoethyl acrylate and 2 wt. parts of CPI-110A (Sanepro Co.) were admixed to prepare an adhesive composition.

### Preparative Example 5

### Preparation of Adhesive Composition

A water soluble solution of 10 wt. % acetoacetyl group-modified polyvinyl alcohol resin [Cosenol 2200, Japan Synthetic Chemical Industry Co. Ltd., a viscosity of 12.5 mPa·sec in 4% water solution, a degree of saponification of 99.5 mol. %] was prepared. Then, this solution was mixed with sodium glyoxalate to reach a ratio by weight (‘weight ratio’) of resin to sodium glyoxalate of 1:0.1 in terms of solid content.

Thereafter, the resulting product was diluted in a solvent having a weight ratio of water to alcohol of 90:10 until a resin concentration reaches 1 wt. part to 100 wt. parts of the solvent, thereby preparing an adhesive composition.

### Preparative Example 5

### Preparation of PSA Composition

A monomer mixture including 97 wt. parts of n-butyl acrylate (BA) and 3 wt. parts of AOEHC (trade name: NK ESTER A-SA) was introduced in a 1 L reactor including refluxed nitrogen gas and equipped with a cooling device for easily controlling a temperature, followed by introducing 100 wt. parts of ethyl acetate (EAc) as a solvent. Next, after purging a nitrogen gas for 1 hour to remove oxygen, the temperature was kept at 62° C. After homogenizing the mixture, 0.07 wt. part of azo bisisobutyronitrile (AIBN) as a reaction initiator was introduced, followed by conducting the reaction for 8 hours, thereby preparing an acryl copolymer having a weight average molecular weight of 1,000,000 or more.

In terms of solid content, to 100 wt. parts of the above prepared acryl copolymer, 0.5 wt. part of tolylene diisocyanate adduct (COR-L) of trimethylol propane and 0.5 wt. part of KBM-403 as two cross-linking agents, and 3 wt. parts of IL-P18-2 as an anti-static agent were added, thereby preparing a PSA composition.

### Preparative Example 5

### Fabrication of Polarizing Plate

A polyvinylalcohol film having an average degree of polymerization of 2,400, a degree of saponification of 99.9 mol. % or more, and a thickness of 20 μm was uniaxially drawn to about five (5) times and immersed in water (distilled water) at 60° C. for 1 minute while maintaining the drawn condition. Following this, the processed film was immersed in a solution having a weight ratio of iodine/potassium iodide/distilled water of 0.05/5/100 at 28° C. for 60 seconds. Next, after immersing the above film in a solution having a weight ratio of potassium iodide/boric acid/distilled water of 8.5/8.5/100 at 72° C. for 300 seconds and washing the same with distilled water at 26° C. for 20 seconds, the resulting product was dried at 65° C. to form a polarizer including the polyvinylalcohol film and iodine adsorbed and aligned in the film.

After applying the adhesive composition prepared in Preparative Example 3 to both surfaces of the polarizer in a thickness of 1 μm, a triacetyl cellulose protective film having a thickness of 25 μm was attached thereto, followed by drying the adhesive, thereby fabricating a polarizing plate.

### Example 1

An alignment film composition was applied to a triacetyl cellulose base film having a thickness of 25 μm according to a die coating process and dried, followed by irradiating the same with UV rays through a wire grid, thereby forming an alignment film.

Next, the composition for forming a polarization coating layer prepared in Preparative Example 1 was applied to the alignment film and dried, followed by curing the same with UV rays, thereby forming a polarization coating layer having a thickness of 4.5 μm.

An alignment film was formed on a PET transcript film having a thickness of 40 μm according to the same process. Further, the composition for forming a retardation coating layer prepared in Preparative Example 2 was applied to the alignment film by a die coating process and dried, followed by curing the same with UV rays, thereby forming a retardation coating layer having a thickness of 4 μm.

Next, the adhesive composition prepared in Preparative Example 3 was applied to the polarization coating layer, the retardation coating layer and the transcript film were laminated on the applied adhesive composition, followed by irradiating the same with UV rays, thereby forming an adhesive layer having a thickness of 1 μm. Thereafter, the transcript film was stripped therefrom to provide a composite polarizing plate.

### Example 2

A composite polarizing plate was fabricated by the same procedures as described in Example 1, except that the adhesive composition was applied to the base film side instead of the polarization coating layer side.

### Example 3

A composite polarizing plate was fabricated by the same procedures as described in Example 1, except that the adhesive composition prepared in Preparative Example 4 was used, and the retardation coating layer has a thickness of 2.5 μm, the adhesive layer has a thickness of 2 μm and the polarization coating layer has a thickness of 3 μm.

### Example 4

A composite polarizing plate was fabricated by the same procedures as described in Example 1, except that the adhesive composition prepared in Preparative Example 5 was used, and the retardation coating layer has a thickness of 3 μm, the adhesive layer has a thickness of 1 μm and the polarization coating layer has a thickness of 4 μm.

### Example 5

A composite polarizing plate was fabricated by the same procedures as described in Example 1, except that the polarization coating layer has a thickness of 10 μm.

### Example 6

A composite polarizing plate was fabricated by the same procedures as described in Example 1, except that the retardation coating layer has a thickness of 10 μm.

### Example 7

A composite polarizing plate was fabricated by the same procedures as described in Example 1, except that the adhesive layer has a thickness of 10 μm.

### Example 8

A composite polarizing plate was fabricated by the same procedures as described in Example 1, except that the polarization coating layer has a thickness of 11.5 μm.

### Example 9

A composite polarizing plate was fabricated by the same procedures as described in Example 1, except that the retardation coating layer has a thickness of 10.5 μm.

### Example 10

A composite polarizing plate was fabricated by the same procedures as described in Example 1, except that the adhesive layer has a thickness of 11 μm.

### Comparative Example 1

A composite polarizing plate was fabricated by the same procedures as described in Example 1, except that the adhesive composition prepared in Preparative Example 6 was used, and the retardation coating layer has a thickness of 2.5 μm, the adhesive layer has a thickness of 1 μm and the polarization coating layer has a thickness of 4 μm.

### Comparative Example 2

A composite polarizing plate was fabricated by the same procedures as described in Example 1, except that the PSA composition prepared in Preparative Example 7 was used instead of the adhesive, and the retardation coating layer has a thickness of 1 μm, the PSA layer has a thickness of 3 μm and the polarization coating layer has a thickness of 2 μm.

### Comparative Example 3

A composite polarizing plate was fabricated by the same procedures as described in Example 2, except that the PSA composition prepared in Preparative Example 7 was used instead of the adhesive.

### Comparative Example 4

A composite polarizing plate was fabricated by the same procedures as described in Example 1, except that the polarizing plate formed in Preparative Example 8 was used instead of the polarization coating layer.

More particularly, the adhesive composition prepared in Preparative Example 3 was applied to the polarizing plate, and the retardation coating layer and the transcript film were laminated thereon, followed by irradiating the same with UV rays to form an adhesive layer. Then, the transcript film was stripped therefrom to provide a composite polarizing plate.

### Comparative Example 5

A composite polarizing plate was fabricated by the same procedures as described in Example 1, except that a polycarbonate-based retardation film having a thickness of 50 μm

(WRS, Teijin Co.) was used instead of the retardation coating layer.

More particularly, the adhesive composition prepared in Preparative Example 3 was applied to the polarization coating layer, and the retardation coating layer was laminated thereon to contact with the adhesive. Then, these layers were adhered together by irradiating the same with UV rays, thereby fabricating the composite polarizing plate.

### Experimental Example

### (1) Measurement of Elastic Modulus

Variation of G′ (storage modulus) was measured by means of Rheometer (MCR-301, Anton Paar Co.). On the stage of this device, the adhesive layer (or PSA layer) prepared in each of the examples and comparative examples was processed into a circumferential specimen having a diameter of 25 mm and a thickness of 1 mm, followed by measuring at a measurement temperature of 25° C. and 1 Hz frequency with a strain rate of 5% by a torsional shear method. Results of the measurement are shown in Table 1.

### (2) Identification of Occurrence of Crack

The polarizing plate fabricated in each of the examples and comparative examples was left at 100° C. for 72 hours while applying flexion with a bending radius of 5 mm such that the polarizing plate is positioned inside and the retardation coating layer (or film) is positioned outside, then, continuously observed. Thereafter, it was monitored through an SEM microscope whether crack occurs on the retardation coating layer (or film) side.

TABLE 1

| | Storage modulus of adhesive | Assessment of |
|---|---|---|
| Section | or PSA layer (Pa) | crack |
| Example 1 | 1.947 × 10⁶ | X |
| Example 2 | 1.947 × 10⁶ | X |
| Example 3 | 2.021 × 10⁶ | X |
| Example 4 | 1.910 × 10⁶ | X |
| Example 5 | 1.947 × 10⁶ | X |
| Example 6 | 1.947 × 10⁶ | X |
| Example 7 | 1.947 × 10⁶ | X |
| Example 8 | 1.947 × 10⁶ | Δ |
| Example 9 | 1.947 × 10⁶ | Δ |
| Example 10 | 1.947 × 10⁶ | Δ |
| Comparative | 8.21 × 10⁵ | ◯ |
| Example 1 | | |
| Comparative | 1.04 × 10⁴ | ◯ |
| Example 2 | | |
| Comparative | 1.04 × 10⁴ | ◯ |
| Example 3 | | |
| Comparative | 1.947 × 10⁶ | ◯ |
| Example 4 | | |
| Comparative | 1.947 × 10⁶ | ◯ |
| Example 5 | | |

◯: no crack occurs over entire layer
Δ: microfine cracks occur in the retardation coating layer (or retardation film)
X: damage of the retardation coating layer (or retardation film) or even the layer under the same

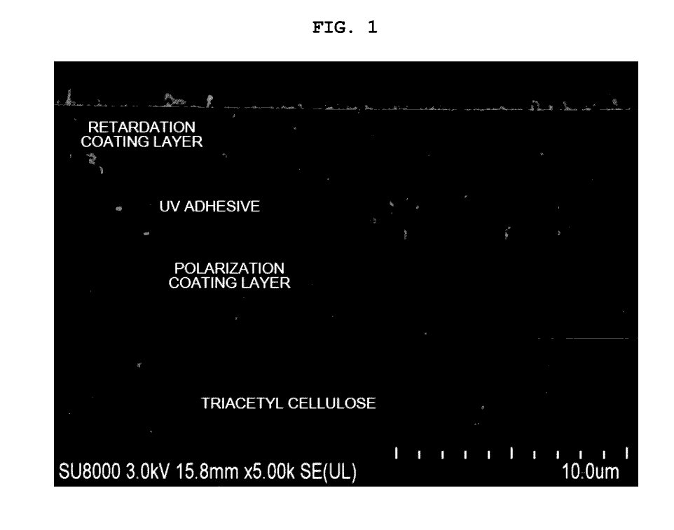

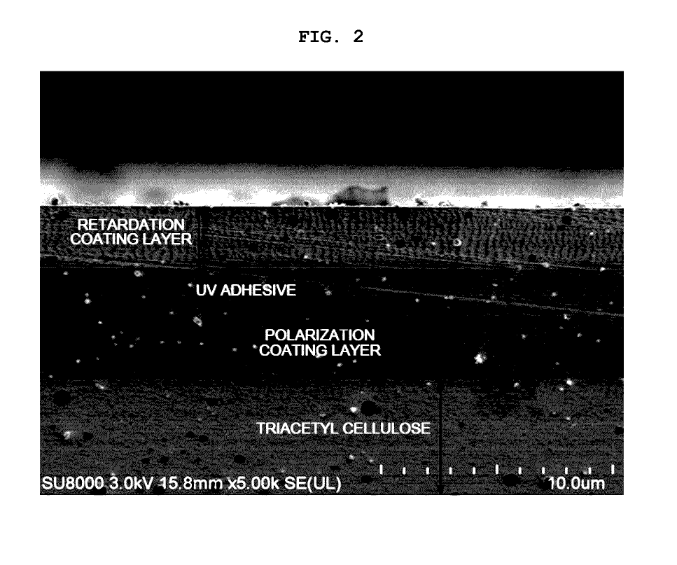

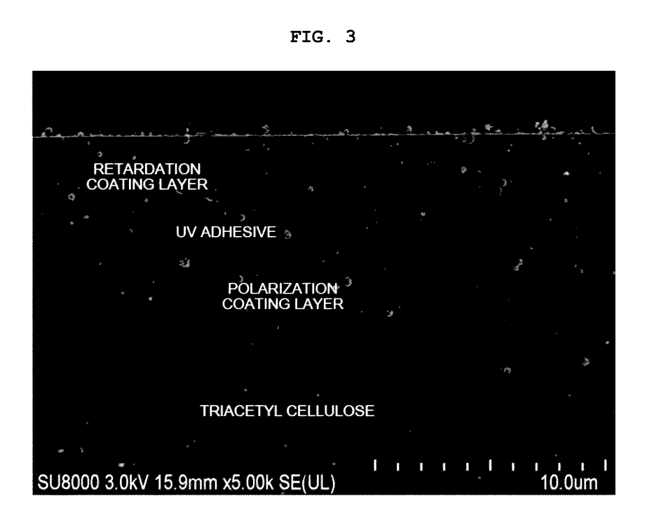

Referring to the above Table 1 and FIGS. 1 to 3, it can be seen that the composite polarizing plate according to each of Examples 1 to 7 did not occur the crack even when flexion was continuously applied, thereby having excellent flexibility and being preferably applied to the flexible display device.

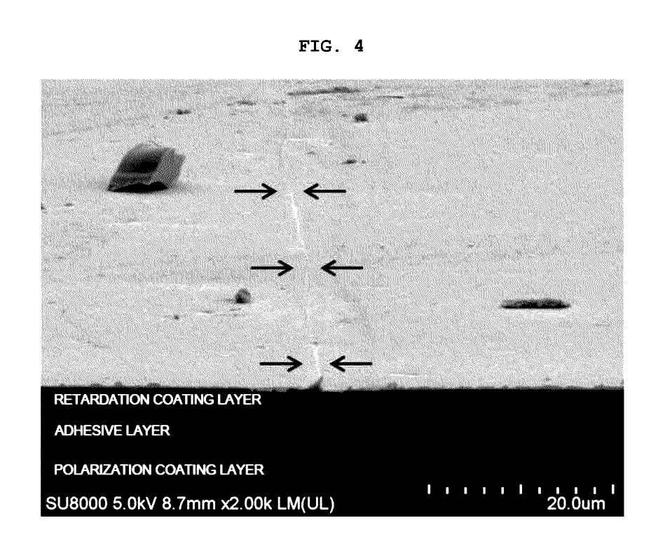

In a case of Examples 8 to 10, although microfine cracks occurred in the retardation coating layer (FIG. 4), these plates still exhibited favorable flexibility.

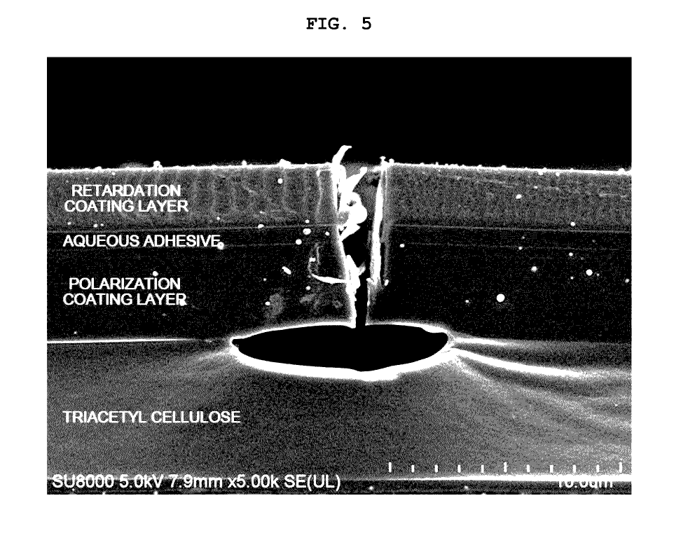

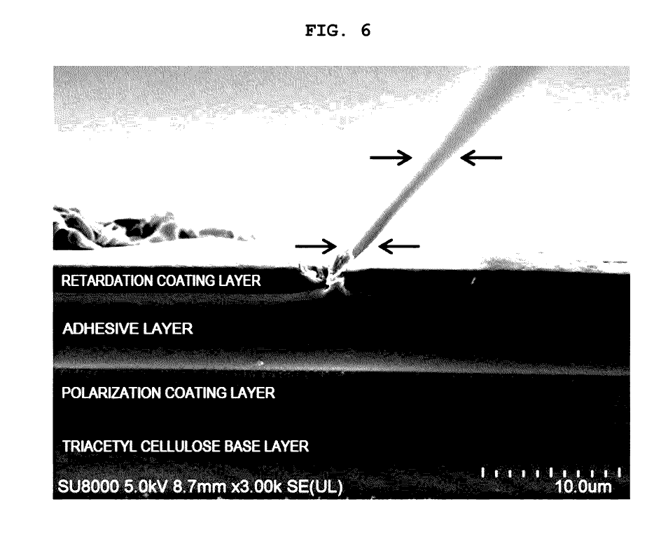

However, it can be seen that the composite polarizing plate fabricated in each of the comparative examples involved damage of the retardation coating layer (or retardation film) due to bending or, what was worse, complete damage of even the layer under the same (FIGS. 5 and 6).

What is claimed is:

1. A composite polarizing plate, comprising:
a polarizing plate having a polarization coating layer formed on one surface thereof;
a retardation coating layer; and
a photo-curable adhesive layer installed between the polarizing plate and the retardation coating layer.

2. The composite polarizing plate according to claim 1, wherein the polarizing plate includes a base film and a polarization coating layer disposed on one surface of the base film.

3. The composite polarizing plate according to claim 1, wherein the polarization coating layer is made of a composition for forming a polarization coating layer which includes a polymerizable liquid crystal compound, a dichroic dye, a leveling agent and a solvent, and
the retardation coating layer is made of a composition for forming a retardation coating layer which includes a polymerizable liquid crystal compound, a leveling agent and a solvent.

4. The composite polarizing plate according to claim 3, wherein the polymerizable liquid crystal compound is represented by Formula 1 below:
U¹-V¹-W¹-X¹-Y¹-X²-Y²-X³-W²-V²-U² [Formula 1]
(wherein X¹, X² and X³ are each substituted or non-substituted p-phenylene or cyclohexane-1,4-diyl group, provided that at least one among these is p-phenylene group;
Y¹ and Y² are each independently direct bond, —CH₂CH₂—, —CH₂O—, —COO—, —OCOO—, —N═N—, —CR^{a}═CR^{b}—, —C≡C— or CR^{a}═N—;
U¹ is a hydrogen atom or polymerizable group;
U² is a polymerizable group;
W¹ and W² are each independently direct bond, —O—, —S—, —COO— or OCOO-group; and
V¹ and V² are each independently substituted or non-substituted alkanediyl group having 1 to 20 carbon atoms).

5. The composite polarizing plate according to claim 1, wherein the polarization coating layer has a thickness of 0.5 to 10 μm, and the retardation coating layer has a thickness of 0.5 to 10 μm.

6. The composite polarizing plate according to claim 1, wherein the photo-curable adhesive layer has an elastic modulus of 10 MPa or more.

7. The composite polarizing plate according to claim 1, wherein the photo-curable adhesive layer has a thickness of 0.5 to 10 μm.

8. An image display device comprising: the composite polarizing plate according to claim 1.
